(19) United States
(12) Patent Application Publication
(10) Pub. No.: US 2005/0004817 A1
(43) Pub. Date: Jan. 6, 2005

(54) Method for processing a data record comprising therapeutic advice items in the course of medical treatment

(76) Inventors: Klaus Abraham-Fuchs, Erlangen (DE); Eva Rumpel, Erlangen (DE); Sven Tiffe, Wien (AT)

Correspondence Address: HARNESS, DICKEY & PIERCE, P.L.C., P.O.BOX 8910, RESTON, VA, 20195, US

(21) Appl. No.: 10/849,041

(22) Filed: May 20, 2004

(30) Foreign Application Priority Data
May 20, 2003 (DE) 10322685.0

(51) Int. Cl. G06F 17/60; G06F 17/00; G06F 7/00

(52) U.S. Cl. 705/3; 707/104.1

(57) ABSTRACT

A method is for processing a data record including therapeutic advice items, particularly for the purpose of quality assurance in the course of medical treatment based on a therapeutic advice item. A first data record, associated with a therapeutic advice item, includes at least one input, at least one output and an expert rule which links the input and the output. The input data items, supplied to the input of the data record associated with the underlying therapeutic advice item, is used to produce, output and/or store individual therapeutic advice items in the form of the output data items. This is preferably done at the output of the data record using the expert rule.

The present application hereby claims priority under 35 U.S.C. §119 on German patent application number DE 103 22 685.0 filed May 20, 2003, the entire contents of which are hereby incorporated herein by reference.

### FIELD OF THE INVENTION

The invention generally relates to a method for processing a data record. The method preferably includes the use of therapeutic advice items for the purpose of quality assurance in the course of medical treatment based on a therapeutic advice item. Such data records are themselves abbreviated to therapeutic advice items below.

Data records, which my be stored in a central database, can include both data, that is to say therapeutic advice items, and executable code, that is to say software fragments, e.g. in the form of expert rules. Therapeutic information items are data items, information items and/or resources relating to a diagnostic and/or therapeutic measure for a patient or for a group of patients.

### BACKGROUND OF THE INVENTION

In recent years, “medical guidelines” (medical practice guidelines or clinical practice guidelines), guidelines for short, have become increasingly significant. Guidelines are diagnostic and/or therapeutic recommendations for action and decisions (subsequently referred to as therapeutic advice items in general and in summary) to the doctor which have been drawn up in a broad consensus by superordinate and generally recognized committees in the medical profession.

Naturally, such guidelines need to be continually brought into line with the latest level of knowledge and are thus subject to continual, if normally long or medium term, change. Typically, guidelines are revised and brought into line at intervals of a few years. In this context, efforts are always made to make continual improvements in treatment for patients on the basis of a diagnostic or therapeutic recommendation in line with such established guidelines, and hence to establish quality assurance measures in medicine too.

In respect of a detailed explanation of therapeutic advice items and therapeutic information items and also their dependencies and interactions, reference is made to the patent application entitled “Method for referencing data records which comprise therapeutic advice items”, which was submitted by the same applicant on the same date (filed in Germany as DE 1032687.7 on May 20, 2003, and being filed in the U.S. on May 20, 2004), the entire contents of which are hereby incorporated herein by reference.

In the prior art, to the best of the applicant's knowledge, no automatically executable methods for assuring the quality of individual therapeutic decisions using therapeutic advice items have been disclosed to date.

### SUMMARY OF THE INVENTION

An embodiment of the invention includes specifying a method for processing data records including therapeutic advice items which makes it a particularly simple matter to perform automatic and safe, and also high-quality, individual data analysis and/or data output for a therapeutic decision.

A method of an embodiment, is for processing a data record including a therapeutic advice item, particularly for the purposes of quality assurance in the course of medical treatment. It preferably has provision for the data record associated with a therapeutic advice item to include at least one input and at least one output and also an expert rule which links the input and the output, and for a second data record including therapeutic information items to be linked to input data items for the first data record associated with the therapeutic advice item in question, such that the input data items are determined from parameters in the therapeutic information item associated with the second data record which are required for the medical treatment, and are supplied to the first data record. The input data items are then used to produce, output and/or store individual therapeutic advice items in the form of the output data items at the output of the first data record using the expert rule.

In one particularly advantageous development, this involves a second data record, which includes therapeutic information items, being linked to the input data items and/or the output data items associated with the first data record for the purpose of treatment in line with a therapeutic advice item. By way of example, to link therapeutic advice items, such as diagnostic and/or therapeutic recommendations for treatment, to therapeutic information items such as patient data items and/or diagnostic and/or therapeutic means and resources, the input data items are preferably determined for a prescribed or relevant therapeutic advice item from parameters in the therapeutic information item which are required for the medical treatment, such as measured data items, findings from previous diagnoses or therapies already performed, and are supplied to the first data record associated with the therapeutic advice item in question.

An embodiment of the invention is based on the insight that the use of modern information and communication technology is currently being greatly expanded in the health service in parallel and independently of the introduction of guidelines in medicine. The use of electronic data processing in hospitals (e.g. HIS=Hospital Information System, RIS=Radiology Information System, PACS=Picture Archive & Communication System, LIS=Laboratory Information System) and in doctor's practices (practice management software, electronic patient records) is becoming more and more usual. A subsequent development step is generally expected to network this software and these databases across the institutions in the health service (clinics, doctor's practices, therapeutic practices etc.). This provides the option of a “networked health service”, at first at national or regional level and later globally. This development provides the basis for use of an embodiment of the invention.

An advantage of an embodiment of the invention is that, for the first time, medical action is generated, processed further, output and/or documented using individual therapeutic advice items in the form of output data items, such as in the form of text or pictures, in an automatically evaluatable manner. It is also possible to check automatically for conformity to established medical therapeutic advice items, particularly to established medical guidelines. This check can relate to individual medics, that is to say to doctors or therapists, to individual medical institutions or to a group of such institutions etc. Hence, with diverse therapies for treating clinical pictures of a similar nature, it is possible to analyze the treatment of such similar clinical pictures across a multiplicity of doctors and institutions in respect of the conformity of the individual therapeutic measures to established therapeutic advice items.

The input data items are expediently supplied to the first data record associated with the therapeutic advice item under event and/or time control. It is also advantageous that the output data items are output automatically or on an event related basis.

By way of example, in the event of identification of specific input data items for a therapeutic information item, such as particular laboratory values for a patient or a diagnosis from a specialist doctor for a patient, and hence under event control, these specific input data items will be supplied to the input of the first data record. Thus, the first data record's expert rule can be used to derive individual therapeutic advice items or the latter can be checked for conformity and then output. The check for concurrence of an individual therapeutic advice item or a recommendation for treatment or a decision for treatment using the expert rule is performed under event control, for example for every fresh diagnosis or for every fresh therapeutic decision, following any transfer to a doctor continuing treatment or following any fresh entry into a patient record, or under time control, for example periodically with a randomly selectable cycle or following every update cycle.

In this case, the output can be made automatically or on an event-related basis. By way of example, the individual therapeutic advice item may be output only in the case of conformity infringement or only in the case of conformity confirmation.

Preferably, the therapeutic advice item is assigned an order feature which is used for clearly identifying the therapeutic advice item. This expediently involves the order feature for that therapeutic advice item which forms the basis of the medical treatment being assigned to the therapeutic information item. This advantageously ensures that the therapeutic information item—e.g. for a patient—is associated with the underlying therapeutic advice item—e.g. a diagnostic or therapeutic recommendation—at any time. In addition, the order feature is advantageously assigned the input data items and/or the output data items for the underlying therapeutic advice item.

Advantageously, the therapeutic information item is assigned at least one optional input data item and/or at least one optional output data item. Thus, a therapeutic information item can also be used for permanently and reconstructably storing such input and output values as are generated in the case of concatenated therapeutic advice items as input values for therapeutic advice items which succeed in such a concatenation or as output values from such therapeutic advice items which succeed in a concatenation.

Additionally or alternatively, the therapeutic information item is assigned at least one further freely definable input data item and/or at least one further freely definable output data item. This makes it a particularly simple matter to store, permanently and reconstructably, further information items, that is to say input and output values which are not required or not provided in line with the underlying therapeutic advice item, in the patient record in addition to the minimum information items.

The information items are stored, in respect of quality assurance measures based thereon, in a particularly beneficial manner if the individual therapeutic advice items generated by the therapeutic advice item at its at least one output are automatically transferred to the respective output data items for the associated therapeutic information item. Intentional or unintentional corruption of the stored information items is thus effectively prevented.

In another preferred embodiment, single instances of output data items associated with the therapeutic information item and/or single instances of input data items, particularly of the freely definable input and output data items, are changed manually in line with a prescribed format, so that a basis is provided for automatic evaluation of the information items contained in the therapeutic information item.

To increase security with respect to intentional or unintentional corruption of the stored information items still further, it is advantageous that, during or prior to a change of individual input or output data items, authorization to do so is checked.

The information items, particularly the input and output data items, possibly including the freely definable input and output data items and/or the optional output data items, are advantageously stored in a data structure which is provided for this purpose and is itself referred to as a treatment step for short, in line with the depiction of the information items and therapeutic instructions which are present at the start of a particular treatment stage, that is to say prior to a treatment step. Every therapeutic advice item may include at least one such data structure, that is to say at least one treatment step.

With a plurality of treatment steps for a single therapeutic information item, these are advantageously assigned in the form of a data structure which is provided as a concatenated list which, after it contains the treatment sequence, is itself likewise referred to as a treatment sequence for short. With a number of input and output data items which is basically not known in advance, these are advantageously stored in the form of data structures representing concatenated lists.

With particular advantage, the input and output data items stored in single or in a plurality of therapeutic information items are used to complement and/or update therapeutic advice items. Hence, a kind of rule group has been established, with a measure of the need to change the therapeutic advice items in question being derived, in particular, from a multiplicity of freely definable input and output values in a plurality of therapeutic information items which are all based on the same therapeutic advice item or on similar therapeutic advice items. When the therapeutic advice items are changed, that is to say are brought into line with the actual circumstances and requirements, the number of freely definable input and output values in those therapeutic information items which are based on the changed therapeutic advice items varies. Other medics benefit from the use of the changed therapeutic advice items on account of their better orientation to the practical instances of application.

Another advantage of an embodiment of the invention and its refinements is that it is quickly possible to identify when patients are being treated incorrectly. It is possible today that patients will be treated incorrectly over a relatively long period of time, because a diagnosis has been made incorrectly at a particular time in the treatment process and this diagnosis is subsequently not examined at all or is examined insufficiently.

In the course of a transfer, a doctor takes on the further treatment of the patient and relies on the diagnosis specified in the patient's notes. This practice makes complete sense, since otherwise multiple examinations would be necessary to a considerable degree with the corresponding burden of cost. In this case, an embodiment of the invention provides the basis for a method of checking the original diagnosis which can be performed with little complexity, so as to be able to identify the minority of patient histories which contain an incorrect diagnosis. Since the criteria for a diagnosis or therapeutic decision may also change over the course of time, for example limit values are raised or lowered or entirely new therapies or technologies are available, it is also possible to identify obsolete diagnoses or therapeutic decisions with the same efficiency.

### BRIEF DESCRIPTION OF THE DRAWINGS

The text below gives a more detailed explanation of an exemplary embodiment of the invention with reference to the drawing figures. Articles or elements which correspond to one another have been provided with the same reference symbols in all figures.

The present invention will become more fully understood from the detailed description of preferred exemplary embodiments given hereinbelow and the accompanying drawing figures, which are given by way of illustration only and thus are not limitative of the present invention, and wherein:

In the drawing:

FIG. 1 shows a schematic illustration of the implementation of a therapeutic advice item in software,

FIG. 2 shows a data record comprising therapeutic information items,

FIG. 3 shows a variant of the therapeutic information item,

FIG. 4 shows a therapeutic information item having freely definable input and output data items,

FIG. 5 shows a therapeutic information item for exclusively documenting exceptional cases,

FIG. 6 shows cascaded (concatenated) therapeutic advice items,

FIG. 7 shows a therapeutic information item for concatenated therapeutic advice items, and

FIG. 8 shows a central database having therapeutic advice items and a local database having therapeutic information items which are based on single therapeutic advice items in the central database.

### DETAILED DESCRIPTION OF THE PREFERRED EMBODIMENTS

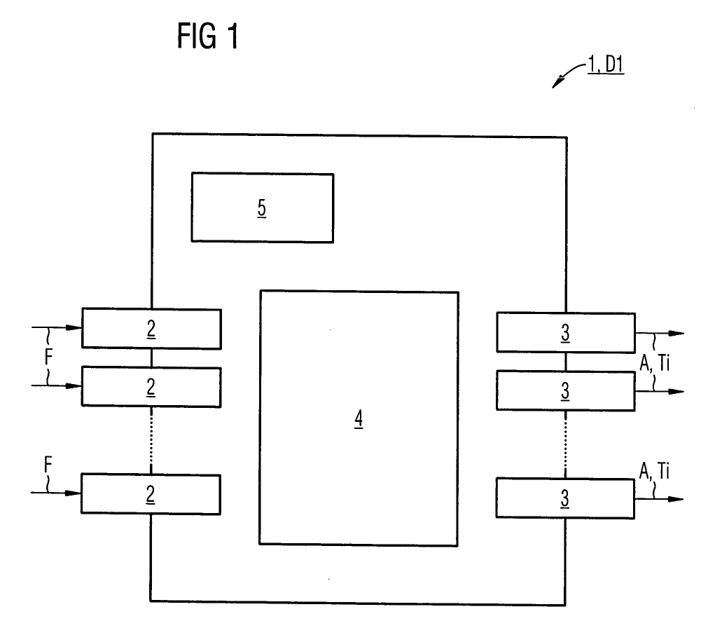

FIG. 1 shows a schematic illustration of a first data record D1 for the software implementation of the basic structure of a medical guideline, that is to say of a therapeutic advice item 1. The first data record D1 including the therapeutic advice item 1 is subsequently referred to as therapeutic advice item for short.

The therapeutic advice item 1, and hence the first data record D1 associated with the therapeutic advice item 1, includes at least one input 2 and at least one output 3. The core of the therapeutic advice item 1 is formed by an expert rule 4. The expert rule 4 takes input data items E, e.g. information items such as patient data items or information items relating to diagnostic and/or therapeutic item(s)/method(s) at the or each input 2, as a basis for generating individual therapeutic advice items Ti in the form of output data items A at one or more outputs 3. The information items at an input 2 may be from various categories, e.g. measured data such as blood pressure, electrocardiogram etc., findings such as a previous diagnosis or actions such as a therapeutic option which has been implemented etc.

Similarly, the individual therapeutic advice items Ti output at the outputs 3 may be from various categories e.g. a finding such as a diagnosis derived from the input values or data items E, a recommendation for action or further data derived from the input data items E. The expert rule 4 is generally an “interference rule” which is used to derive single or a plurality of individual therapeutic advice items 1 from the input data items E.

Every therapeutic advice item 1 includes an order feature 5 clearly identifying the therapeutic advice item 1. The order feature 5 is suitable and provided for the purpose of referencing a therapeutic advice item 1 which, by way of example, is stored in a central database (not shown) and is used in a medical institution.

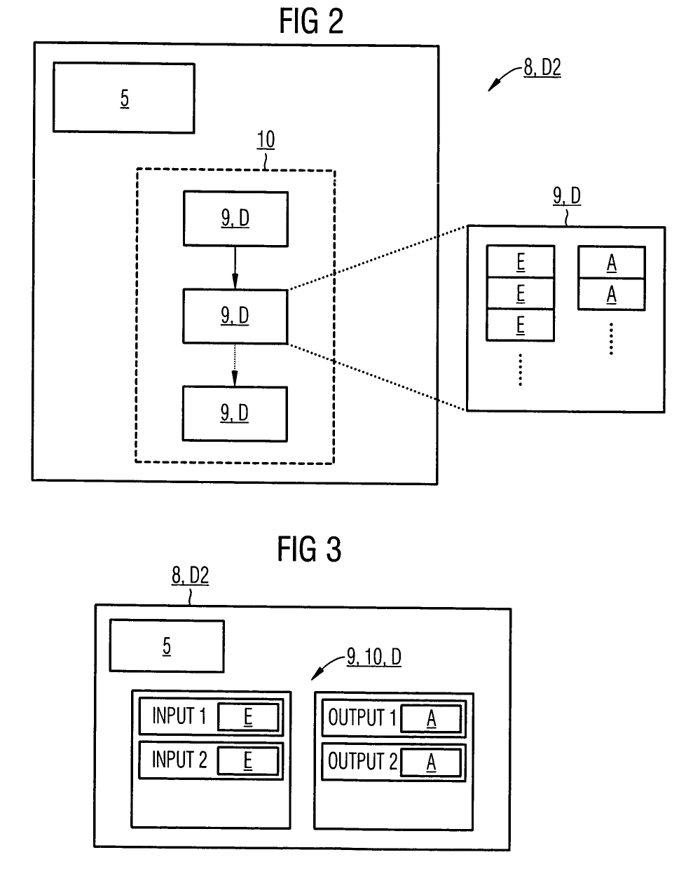

FIG. 2 schematically shows a second data record D2 which includes therapeutic information items 8 and is managed by the medical institution, that is to say, by way of example, the doctor's practice or the clinic, for every patient or possibly for a group of patients. Such a second data record D2 including therapeutic information items 8 is subsequently also referred to as a therapeutic information item 8 for short. A customary form of therapeutic information item 8 is an electronic patient record. The therapeutic information item 8 can also extend, on a case by case basis, to physically distributed databases. Subsequently, however, what is more important is the layout of such a therapeutic information item 8 and the respective information items stored and linked to one another, rather than the specific storage location of individual or all information items or data items.

Every therapeutic information item 8 includes the order feature 5 for that therapeutic advice item 1 on which the therapeutic information item 8 is based. That is to say, every patient record is assigned the order feature 5 of the therapeutic advice item 1 in question, in particular stored there in the second data record D2, for the purpose of documenting the medical treatment of the patient. Together with the order feature 5, data relating to the start, relating to the previous duration, relating to the probable or actual end of medical treatment etc. are stored as required.

For the purpose of precise and safe documentation of the medical treatment, the therapeutic information item 8 includes data items D relating to individual treatment steps 9, that is to say firstly descriptions or listings of symptoms, measured values and the like, and secondly medications and the like. The data items D stored in this context may also be information items relating to diagnostic and/or therapeutic items/methods/devices or resources.

Every single treatment step 9 is stored in a treatment sequence 10. The treatment sequence 10 is, by way of example, a “concatenated list”, with each list element being formed by a treatment step 9. The treatment sequence 10 can be used to continue to document treatment steps 9 which are in the past, using the data items D. In addition, the historical development of the treatment can be reconstructed at any time. The simplest form of a treatment sequence 10 is a treatment sequence 10 with just one treatment step 9. In that case, the treatment sequence 10 and the treatment step 9 are identical.

As data items D, every treatment step 9 includes, that is to say by way of example, symptoms and measured values which are transmitted to the therapeutic advice item 1 referenced by the respective order feature 5 or to the expert rule 4 for the therapeutic advice item 1 at the latter's inputs 2 as input data items E. The individual therapeutic advice items 1, that is to say medications, for example, which are subsequently generated by the expert rule 4 are produced as output data items A at the output 3 of the first data record D1 and are linked to the second data record D2 for the therapeutic information item 8, such that, by way of example, the output data items A are stored in the respective treatment step 9. Input and output data items E and A can thus be output and stored in the respective treatment step 9 either directly or indirectly, i.e. using referencing of the actual output or storage location.

As a result, if a plurality of consecutive treatment steps 9 are involved, for example, it is possible for the same output data items A to be repeatedly generated or for the same or at least partially the same input data items E to be repeatedly accepted. Multiple entries are prevented by virtue of identical input or output data items E, A referencing a storage location having the same respective input or output data item E or A a plurality of times. Since, depending on the degree and scope of the documentation of the medical treatment, the number of available input data items E and/or the number of output data items A may vary, the input and/or output data items E and A may also be stored, by way of example, in an input or output data list (not shown), particularly in the form of a concatenated list. This allows dynamic provision of storage space, according to need, for as many input and output data items E and A as are available or generated in the specific treatment step 9.

FIG. 3 shows a variant of the therapeutic information item 8 from FIG. 2. The variant of the therapeutic information item 8 is shown as a therapeutic information item 8 with a treatment sequence 10 with just one treatment step 9, i.e. the therapeutic information item 8 includes just one group of inputs E and just one group of outputs A. The data structure of the therapeutic information item 8 is displayed, in an illustration as in FIG. 3, on a user interface on a workstation computer, that is to say, by way of example, a personal computer used by a doctor in his consultation or treatment room.

The input data items E, such as measured data, e.g. ECG data, may be entered into the therapeutic information item 8 either manually or using customary “drag and drop” techniques. It is also possible for a reference to the storage location of the input data items E to be entered instead of the actual input data items E. The output data items A derived using the therapeutic advice item 1 on the basis of the expert rules 4 are marked in the first data record D1 and, in addition, are optionally (e.g. a diagnosis) or automatically entered into the therapeutic information item 8.

When the therapeutic advice item 1 on which the therapeutic information item 8 is based is evaluated by the doctor or therapist, the output data items A from the first data record D1 are entered into the second data record D2 manually. If the expert rule 4 on which the therapeutic advice item 1 is based is implemented electronically, the output data items A from the first data record D1 can also be entered automatically into the second data record D2 itself.

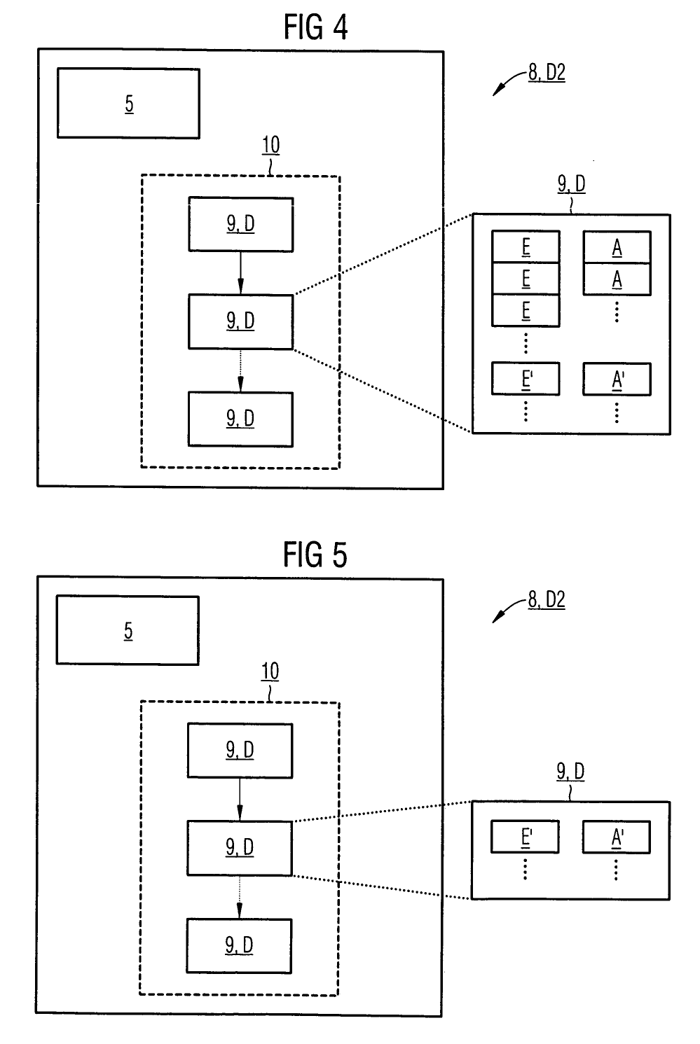

FIG. 4 schematically shows a therapeutic information item 8. The therapeutic information item 8 comprises input and output data items E, A, like the therapeutic information item 8 from FIG. 2. In addition, for the respective treatment step 9, provision is made for freely definable input data items E′ to be specified and for freely definable output data items A′ to be specified which are added for the purpose of more accurate or more comprehensive documentation, for example. Using the freely definable input and output data items E′ and A′, the doctor or therapist can record, by way of example, exceptional cases and, for these, the respective additional input and output data items E and A required.

FIG. 5 shows a therapeutic information item 8 for exclusively documenting exceptional cases. The therapeutic information item 8 therefore includes only freely definable input and output data items E′, A′. Such a reduced or minimized form for the therapeutic information item 8 is suitable particularly when the therapeutic advice item 1 on which the therapeutic information item 8 is based is “trivial”, i.e. when the “normal” input and output data items E, A need to be derived from the underlying therapeutic advice item 1 itself every time.

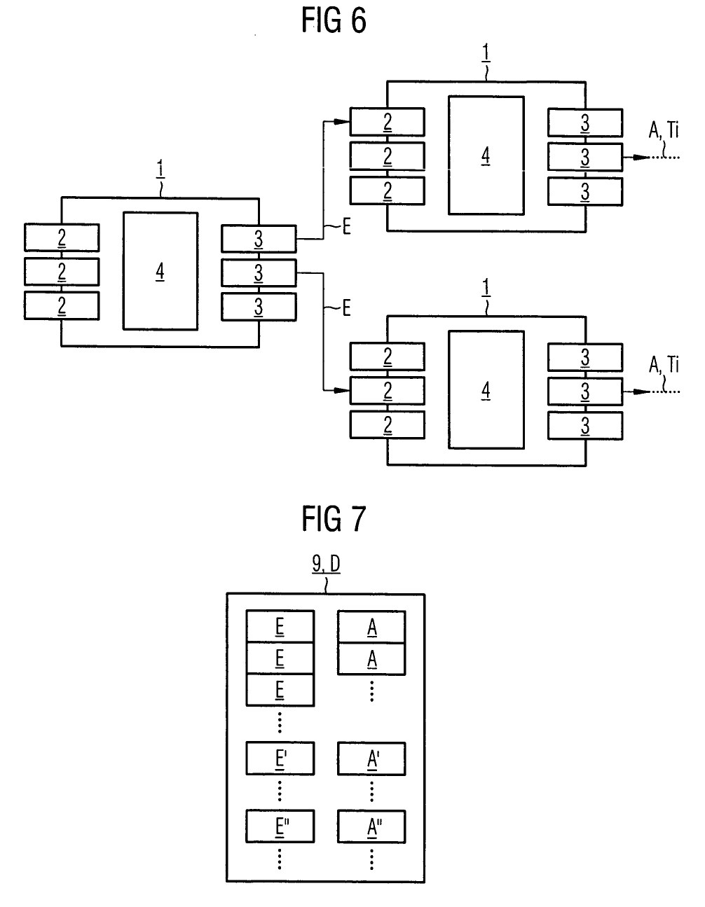

FIG. 6 shows cascaded therapeutic advice items 1. Such cascaded, that is to say concatenated, therapeutic advice items 1 allow for the fact that complex therapeutic advice items 1 or medical guidelines comprise a concatenation of a plurality of expert rules 4. The concatenation is obtained from the fact that an output 3 for a first expert rule 4 forms the input 2 for a subordinate further expert rule 4.

FIG. 7 shows a therapeutic information item 8 for concatenated therapeutic advice items 1 in a treatment step 9. Single input and output data items E and A are provided as “primary” input and output data items E, A in relation to the first therapeutic advice item 1 in the concatenated therapeutic advice items 1. In addition, freely definable input and output data items E′, A′ are provided which are associated with individual therapeutic advice items 1 in the concatenated therapeutic advice items 1. Finally, optional input and output data items E″, A″ are provided which are necessary for further therapeutic advice items 1 along the concatenation of concatenated therapeutic advice items 1.

The input and output data items E, E″ and A, A″ and also the freely definable input and output data items E′, A′ are stored and archived in order to make use of the opportunity to inform medical institutions, particularly such institutions as create and/or manage the therapeutic advice items 1, about the frequency and type of exceptional cases. The institution informed in this way is then able to adjust or extend the respective therapeutic advice items 1 if the exceptional cases arise with the relevant frequency.

The relevant institution can adjust or extend the therapeutic advice items 1 in a particularly efficient and direct manner when data items stored in the therapeutic advice items 8, that is to say the input and output data items E, E″ and A, A″ and also the freely definable input and output data items E′, A′, are transmitted to the institution. The data items D are preferably forwarded in anonymous form, i.e. without the name of the patient etc. From these data items D, it is possible, particularly if they are delivered by a multiplicity of institutions, to create a statistic. This statistic allows, by way of example, a statement about which output data items A, A′, A″ arise particularly frequently.

In addition, such a statistic allows comparison of the frequency of therapeutic information items 8 without freely definable input and output data items E, E″, A, A″ (foreseen cases) with the frequency of therapeutic information items with freely definable input and output data items E′, A′ (exceptional cases). On the basis of such a frequency analysis, it is possible to derive a measure of the need to change or complement a therapeutic advice item 1. If the freely definable input and output data items E′, A′ have been forwarded to the relevant institution, then they, or at least those with significant frequency, can be incorporated into the expert rule 4 for the therapeutic advice item 1 which is to be changed or complemented.

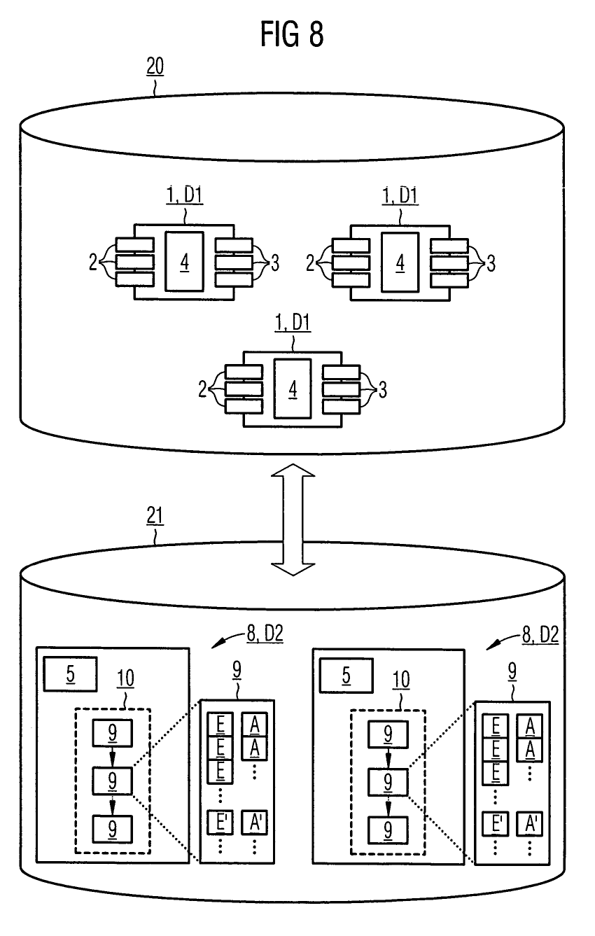

This interaction between the individual therapeutic information items 8 and the therapeutic advice items 1 on which they are based is shown schematically in FIG. 8. The therapeutic advice items 1 are stored in a central database 20 using a plurality of first data records D1. The central database 20 is operated by a superordinate medical institution, e.g. by a recognized committee for the medical profession. The therapeutic information items 8 are stored in a local database 21 using a plurality of second data records D2. This local database is operated by a local medical institution, that is to say, by way of example, a clinic, for a doctor's practice etc.

In the local database 21, the individual therapeutic information items 8 with the progressive treatment which they describe are updated under event or time control. The treating medic, that is to say the doctor or therapist, enters input data items E, E″ into the respective therapeutic information item 8. If the expert rule 4 for the underlying therapeutic advice item 1 is applied automatically, then the generated output data items A, A″ are also entered in the therapeutic information item 8 automatically. If the medic adheres to the therapeutic advice item 1, then no inconsistency may arise in this case. If the expert rule 4 is applied by the medic himself, then the medic himself enters the output data items A, A″ which he has ascertained into the therapeutic information item 8.

If output data items A, A″ are input only in line with a prescribed format, i.e. automatic evaluation of the output data items A, A″ which have been input is possible, then the output data items A, A″ which have been ascertained and input by the medic can be compared at a later time with output data items A, A″ which would have been obtained upon automatic application of the expert rule 4. In this way, any treatment errors by the medic or else any shortcomings in the expert rule 4 may be identified.

If the medic wishes to depart from the output data items A, A″ from the expert rule 4 which are ascertained automatically, under time or event control, then while documenting such a step in the therapeutic information item 8 he uses freely definable input and output data items E′, A′ provided for this purpose. These freely definable input and output data items E′, A′ are stored in the respective information item 8 and may be used at the institution operating the central database 20 in order to identify any need for addition to the therapeutic advice items 1. Such a need for addition may relate to revision or complementing of individual therapeutic advice items 1, to the need for replacement of an (obsolete) therapeutic advice item 1 and to the production of new therapeutic advice items 1 which have not yet been provided to date etc.

Checking diagnoses and therapeutic decisions from the past involves the use of superordinate control mechanisms whose type and structure correspond to those of a therapeutic advice item 1 and which are therefore also not illustrated separately. In this case, the following practices are possible: taking a diagnosis or therapeutic decision which is set out in a therapeutic information item 8 (patient record) as a starting point, the associated control mechanism (=expert rule 4) is selected, e.g. on the basis of codes or on the basis of the patient data. There is then a test to determine whether the therapeutic information item 8 has the data items D required by the control mechanism. Depending on the result, the conformity of the diagnosis or therapeutic decision (=individual therapeutic advice item Ti) to the control mechanism is acknowledged or a negative acknowledgment is output.

If the diagnosis or therapeutic decision made did not conform to the control mechanism, then the unfulfilled conditions of the control mechanism are pointed out. In addition, or alternatively, the control mechanism respectively used for analysis may be used to propose additional examinations which could be confirmed by the diagnosis or therapeutic decision.

Furthermore, that is to say once again in addition or alternatively, the respectively control mechanism used for analysis may also be used to output advice of clinical pictures or symptoms for which confusion arises with particular frequency. If such confusion is conceivable, then alternative diagnoses are specified, particularly with advice of what additional examinations they require.

Diagnoses and therapeutic decisions from the past are preferably checked for every new diagnosis, following any transfer to a doctor who is continuing treatment, whenever a new entry is made in the patient record, periodically at prescribed, or prescribable, in particular equidistant, times or whenever the control mechanism or the therapeutic advice items are updated and hence under time and/or event control.

Any of the aforementioned methods may be embodied in the form of a program. The program may be stored on a computer readable media and is adapted to perform any one of the aforementioned methods when run on a computer. Thus, the storage medium or computer readable medium, is adapted to store information and is adapted to interact with a data processing facility or computer to perform the method of any of the above mentioned embodiments.

The storage medium may be a built-in medium installed inside a computer main body or removable medium arranged so that it can be separated from the computer main body. Examples of the built-in medium include, but are not limited to, rewriteable involatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable involatile memory, such as memory cards; and media with a built-in ROM, such as ROM cassettes.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for processing data records, including a therapeutic advice item, in the course of medical treatment, wherein a first data record is associated with the therapeutic advice item, the first data record including at least one input, at least one output and at least one expert rule linking the input and the output, the method comprising:
linking a second data record, including at least one therapeutic information item, to at least one input data item of the first data record associated with the therapeutic advice item;
determining the at least one input data item from at least one parameter in the at least one therapeutic information item of the second data record required for the medical treatment, and supplied to the first data record; and
at least one of outputting and storing, using the at least one input data item, at least one individual therapeutic advice item in the form of an output data item at the output of the data record using the expert rule.

2. The method as claimed in claim 1, wherein the at least one input data item is supplied to the first data record associated with the therapeutic advice item under at least one of event and time control.

3. The method as claimed in claim 1, wherein the at least one output data item is output at least one of automatically and on an event related basis.

4. The method as claimed in claim 1, wherein the therapeutic advice item is assigned an order feature, used for clearly identifying the therapeutic advice item.

5. The method as claimed in claim 4, wherein the order feature associated with that therapeutic advice item which forms the basis of the medical treatment is assigned to the therapeutic information item.

6. The method as claimed in claim 4, wherein the order feature is assigned at least one of the input data item and the output data item associated with the underlying therapeutic advice item.

7. The method as claimed in claim 1, wherein the therapeutic information item is assigned at least one of at least one optional input data item and at least one optional output data item associated with the underlying therapeutic advice item.

8. The method as claimed in claim 1, wherein the therapeutic information item is assigned at least one of at least one further freely definable input data item and at least one further freely definable output data item associated with the therapeutic advice item.

9. The method as claimed in claim 1, wherein the individual therapeutic advice items generated by the therapeutic advice item at the latter's output are automatically transferred to the respective output data items from the associated therapeutic information item.

10. The method as claimed in claim 1, wherein at least one of individual output data items and input data items associated with the therapeutic information item are changed in line with a prescribed format.

11. The method as claimed in claim 10, wherein, at least one of during and prior to a change of at least one of individual input data items and output data items associated with the therapeutic information item, authorization to do so is checked.

12. The method as claimed in claim 1, wherein at least one of the input data items and output data items stored in at least one of individual and in a plurality of therapeutic information items are used to at least one of complement and update therapeutic advice items.

13. The method as claimed in claim 1, wherein the therapeutic advice item is divided into a plurality of therapeutic advice items concatenated with one another, and wherein at least one of the and each input data item is supplied to a first therapeutic advice item in the concatenation of concatenated therapeutic advice items.

14. The method as claimed in claim 13, wherein at least one of the and each optional input data item is supplied to a therapeutic advice item succeeding the first therapeutic advice item in the concatenation of concatenated therapeutic advice items.

15. The method as claimed in claim 13, wherein the output data item associated with the first therapeutic advice item in the concatenation of concatenated therapeutic advice items is used to generate and output individual therapeutic advice items at the first therapeutic advice item's at least one output.

16. The method as claimed in claim 13, wherein the optional output data item associated with a therapeutic advice item succeeding the first therapeutic advice item in the concatenation of concatenated therapeutic advice items is used to generate and output further individual therapeutic advice items at the succeeding therapeutic advice item's at least one output.

17. The method as claimed in claim 1, wherein at least one of the input data items and output data items stored in at least one of individual and in a plurality of therapeutic information items, are used to check at least one of diagnoses and therapeutic decisions.

18. The method as claimed in claim 1, wherein each therapeutic advice item includes at least one treatment step and wherein the therapeutic information item is assigned a plurality of treatment steps in the form of a treatment sequence implemented as a concatenated list.

19. The method as claimed in claim 2, wherein the at least one output data item is output at least one of automatically and on an event related basis.

20. The method as claimed in claim 5, wherein the order feature is assigned at least one of the input data item and the output data item associated with the underlying therapeutic advice item.

21. The method as claimed in claim 2, wherein the therapeutic information item is assigned at least one of at least one optional input data item and at least one optional output data item associated with the underlying therapeutic advice item.

22. The method as claimed in claim 2, wherein the therapeutic information item is assigned at least one of at least one further freely definable input data item and at least one further freely definable output data item associated with the therapeutic advice item.

23. The method as claimed in claim 3, wherein the therapeutic information item is assigned at least one of at least one optional input data item and at least one optional output data item associated with the underlying therapeutic advice item.

24. The method as claimed in claim 3, wherein the therapeutic information item is assigned at least one of at least one further freely definable input data item and at least one further freely definable output data item associated with the therapeutic advice item.

25. The method as claimed in claim 14, wherein the output data item associated with the first therapeutic advice item in the concatenation of concatenated therapeutic advice items is used to generate and output individual therapeutic advice items at the first therapeutic advice item's at least one output.

26. The method as claimed in claim 14, wherein the optional output data item associated with a therapeutic advice item succeeding the first therapeutic advice item in the concatenation of concatenated therapeutic advice items is used to generate and output further individual therapeutic advice items at the succeeding therapeutic advice item's at least one output.

27. The method as claimed in claim 15, wherein the optional output data item associated with a therapeutic advice item succeeding the first therapeutic advice item in the concatenation of concatenated therapeutic advice items is used to generate and output further individual therapeutic advice items at the succeeding therapeutic advice item's at least one output.

28. The method as claimed in claim 2, wherein each therapeutic advice item includes at least one treatment step and wherein the therapeutic information item is assigned a plurality of treatment steps in the form of a treatment sequence implemented as a concatenated list.

29. The method as claimed in claim 3, wherein each therapeutic advice item includes at least one treatment step and wherein the therapeutic information item is assigned a plurality of treatment steps in the form of a treatment sequence implemented as a concatented list.

30. A method for processing data records, including a therapeutic advice item, wherein a first data record is associated with the therapeutic advice item and includes at least one input, at least one output and at least one expert rule linking the input and the output, and wherein a second data record, including at least one therapeutic information item, is linked to at least one input data item of the first data record, the method comprising:
determining the at least one input data item from at least one parameter in the at least one therapeutic information item of the second data record, and supplied to the first data record; and
at least one of outputting and storing, using the at least one input data item, at least one individual therapeutic advice item in the form of an output data item.

31. The method of claim 30, wherein the method is for quality assurance in the course of medical treatment based on the therapeutic advice item.

32. The method of claim 30, wherein the outputting of the data record is done using the expert rule.

33. A program, adapted to perform the method of claim 1, when executed on a computer.

34. A computer readable medium, storing the program of claim 33.

35. A program, adapted to perform the method of claim 30, when executed on a computer.

36. A computer readable medium, storing the program of claim 35.

37. An apparatus for processing data records, including a therapeutic advice item, in the course of medical treatment, wherein a first data record is associated with the therapeutic advice item, the first data record including at least one input, at least one output and at least one expert rule linking the input and the output, the apparatus comprising:
means for linking a second data record, including at least one therapeutic information item, to at least one input data item of the first data record associated with the therapeutic advice item;
means for determining the at least one input data item from at least one parameter in the at least one therapeutic information item of the second data record required for the medical treatment, and supplied to the first data record; and
means for at least one of outputting and storing, using the at least one input data item, at least one individual therapeutic advice item in the form of an output data item at the output of the data record using the expert rule.

38. An apparatus for processing data records, including a therapeutic advice item, wherein a first data record is associated with the therapeutic advice item and includes at least one input, at least one output and at least one expert rule linking the input and the output, and wherein a second data record, including at least one therapeutic information item, is linked to at least one input data item of the first data record, the apparatus comprising:
means for determining the at least one input data item from at least one parameter in the at least one therapeutic information item of the second data record, and supplied to the first data record; and
means for at least one of outputting and storing, using the at least one input data item, at least one individual therapeutic advice item in the form of an output data item.
